(19) United States
(12) Patent Application Publication
(10) Pub. No.: US 2024/0394588 A1
(43) Pub. Date: Nov. 28, 2024

(54) MACHINE LEARNING FORECASTING BASED ON RESIDUAL PREDICTIONS

(71) Applicant: The Toronto-Dominion Bank, Toronto (CA)

(72) Inventors: Holly HEGLAN, Toronto (CA); Brendan Kolisnik, Toronto (CA)

(21) Appl. No.: 18/321,982

(22) Filed: May 23, 2023

(51) Int. Cl. G06N 20/00

(52) U.S. Cl. CPC G06N 20/00

(57) ABSTRACT

The present disclosure generally relates to systems, software, and computer-implemented methods for machine learning forecasting. One example method includes obtaining, using a first machine learning model, a first prediction predicting a variable for a first time period. A second prediction can be obtained, using a second machine learning model, to predict a residual of the first machine learning model for a second time period, where the first time period includes the second time period, and where the second machine learning model is trained based on at least a part of the first prediction. The first prediction and the second prediction can be combined to generate a combined prediction. One or more action recommendations can be generated based on the combined prediction.

### TECHNICAL FIELD

The present disclosure generally relates to data processing techniques and provide computer-implemented methods, software, and systems for improving forecasting accuracies based on adjusting the initial prediction of a long-term model with the residual prediction of a short-term model.

### BACKGROUND

Data modelling involves design of algorithms that adapt machine learning model to improve their ability to process data and make predictions. More specifically, data modeling is an approach to data analysis that involves building and adapting models. Data modelling can be applied to a variety of areas such as prediction systems, search engines, medical diagnosis, natural language modelling, autonomous driving, etc. One application of machine learning-based model includes forecasting future values based on historical data. A forecasting model is typically trained using features of historical data for a variable over a past period of time. The trained forecasting model can then generate a prediction for the variable at a future point of time.

### SUMMARY

The present disclosure generally relates to systems, software, and computer-implemented methods for improving forecasting accuracies based on adjusting the initial prediction of a long-term model with the residual prediction of a short-term model.

A first example method includes obtaining, using a first machine learning model, a first prediction predicting a variable for a first time period. A second prediction predicting a residual of the first machine learning model for a second time period can be obtained using a second machine learning model, where the first time period includes the second time period, and where the second machine learning model is trained based on at least a part of the first prediction. The first prediction and the second prediction can be combined to generate a combined prediction. One or more action recommendations can be generated based on the combined prediction.

Implementations can optionally include one or more of the following features.

In some implementations, the first example method includes obtaining one or more past residuals of the first machine learning model, and training, using the one or more past residuals, the second machine learning model.

In some implementations, obtaining the one or more past residuals of the first machine learning model includes obtaining the at least a part of the first prediction, where the at least a part of the first prediction is associated with a third time period, and the first time period includes the third time period. An actual observation value of the variable for the third time period can be obtained. The at least a part of the first prediction can be subtracted from the actual observation value to generate a past residual.

In some implementations, the first time period is relatively longer than the second time period.

In some implementations, combining the first prediction and the second prediction to generate the combined prediction includes adding the second prediction to the at least a part of first prediction.

In some implementations, generating the one or more action recommendations based on the combined prediction includes determining one or more Shapley values associated with the combined prediction, and determining that the one or more Shapley values satisfy one or more conditions.

In some implementations, the first example method includes in response to determining that the one or more Shapley values satisfy the one or more conditions, adding one or more actions to the one or more action recommendations.

In some implementations, the one or more conditions include a condition that a sum of Shapley values associated with the first machine learning model are less than a predetermined ratio of a total sum of the Shapley values associated with the first machine learning model and Shapley values associated with the second machine learning model, and where the one or more actions include retraining the first machine learning model.

In some implementations, the first example method includes in response to determining that the sum of Shapley values associated with the first machine learning model are less than the predetermined ratio of the total sum of the Shapley values associated with the first machine learning model and the Shapley values associated with the second machine learning model, automatically triggering retraining of the first machine learning model.

In some implementations, the first machine learning model and the second machine learning model have at least one different feature.

Similar operations and processes associated with each example system can be performed in different systems comprising at least one processor and a memory communicatively coupled to the at least one processor where the memory stores instructions that when executed cause the at least one processor to perform the operations. Further, a non-transitory computer-readable medium storing instructions which, when executed, cause at least one processor to perform the operations can also be contemplated. Additionally, similar operations can be associated with or provided as computer-implemented software embodied on tangible, non-transitory media that processes and transforms the respective data, some or all of the aspects can be computer-implemented methods or further included in respective systems or other devices for performing this described functionality. The details of these and other aspects and embodiments of the present disclosure are set forth in the accompanying drawings and the description below. Other features, objects, and advantages of the disclosure will be apparent from the description and drawings, and from the claims.

The techniques described herein can be implemented to achieve the following advantages. For example, in some cases, the techniques described herein can improve forecasting accuracy by adjusting a long-term prediction with a residual prediction. The residual prediction can be generated by a short-term model that specializes in correcting for the long-term model's errors. Adjusting the long-term prediction with the residual prediction can reduce the errors of long-term model which typically does not take into account recent events that deviate from the past data patterns relied upon by the long-term model. Improved accuracy can further result in greater computing resource efficiencies. For example, conventional methods can cost large amounts of computing resources to correct a long-term prediction. In contrast, with the improved forecasting accuracy, the techniques described herein can reduce the computing resource consumptions and improve the computing resource efficiencies.

As another example, in some instances, the techniques described herein allow to explain the long-term prediction and/or the residual prediction, which in turn can improve confidence on the action recommendation(s). For example, the techniques described herein can use Shapley values to show the contribution or the importance of each feature on the prediction of the model. In some cases, the action recommendation(s) can be automatically executed and/or adjusted if the Shapley values satisfy certain condition(s).

As yet another example, in some implementations, the techniques described herein enable to automatically execute action(s) based on the prediction results with less human intervention, in particular in light of the more trustworthy prediction results. As discussed above, the techniques described herein can enhance the prediction accuracy, and the explainability of the prediction results further boosts the confidence on the prediction. Therefore, less human intervention is needed to evaluate the prediction results and/or adjust action plan(s).

### DESCRIPTION OF DRAWINGS

FIG. 1 is a block diagram of a networked environment for improving forecasting accuracies based on adjusting the initial prediction of a long-term model with the residual prediction of a short-term model.

FIG. 2 illustrates an example data and control flow of example interactions performed for improving forecasting accuracies based on adjusting the initial prediction of a long-term model with the residual prediction of a short-term model.

FIG. 3 is a flow diagram of an example method for improving forecasting accuracies based on adjusting the initial prediction of a long-term model with the residual prediction of a short-term model.

FIG. 4 illustrates an example process for improving forecasting accuracies based on adjusting the initial prediction of a long-term model with the residual prediction of a short-term model.

### DETAILED DESCRIPTION

The present disclosure generally relates to various tools and techniques associated with improving forecasting accuracies based on techniques for adjusting the initial prediction of a long-term model using the residual prediction of a short-term model. One example application of the techniques described herein is in the context of consumer communications forecast (e.g., predicting call volumes and/or average handle time (AHT) of calls made by consumers). Although the techniques herein are described in the context of this application, it will be appreciated that these techniques are applicable in the context of other applications as well. For brevity and case of description, the following example description is provided in the context of consumer communications forecast (e.g., forecasting call volume and/or AHT).

In some cases, one single machine learning model can be employed to generate predictions. The historical data used to train the machine learning model typically demonstrates a particular pattern, which is then relied upon by the machine learning model to generate future predictions. So, for example, if the historical data indicates that call volume to a call center is typically high in December of past years, the machine learning model can predict that the call volume will continue to be high in December of the upcoming year. However, such a method suffers from multiple deficiencies.

First, while the historical data can demonstrate some particular pattern, the actual data pattern can sometimes significantly, or critically, deviate from the particular pattern, leading to inaccurate predictions. On one hand, some irregular events that seldom occurred or occurred at uncertain times in the past would unlikely be captured in the past data pattern. However, these events can change, sometimes significantly, the future data pattern. As a result, the predictions relying on the past data pattern would not be accurate. On the other hand, some events could occur in the past and be captured in the past data pattern. However, these events may not occur again in the future. If the machine learning model is trained with this past data pattern and the events do not occur again, the predictions of the machine learning model can also deviate from the actual data pattern.

Second, due to the inaccurate predictions as discussed above, large quantities of computing resources and/or human hours can be required to readjust the forecasts. This not only results in low computing resource efficiencies, but can also delay the outcomes of predictions.

Third, some methods use machine learning models whose prediction results cannot be explained-the relative contribution or the relative importance of each feature on the prediction of the model is unknown. As the rationale behind the prediction results is unknown, large quantities of computing resources and/or human hours can be required to validate the prediction results and/or adjust the action(s) recommended by the machine learning models.

These deficiencies can be illustrated by the following example. A call center needs to forecast call volume and/or AHT for a phone channel. These predictions are needed in the short-term for staffing decisions, such as determining the number of call center staff to be on duty on a certain day, week, etc. These predictions are also needed for hiring decisions-that is, determining the number of employees needed to handle the forecasted call volume and AHT. Such hiring predictions need to be made early, as training a new hire can take a long time (e.g., about 3 months). To calculate the needs of the organization, a machine learning model is trained based on the past call volumes and/or AHTs to forecast future call volumes and/or AHTs. However, some irregular events (e.g., upcoming promotion events, pandemics, etc.) can lead to a surge of the call volume and/or AHT. The machine learning model cannot take into account such irregular events, and thus its predictions may not be consistently accurate. As a result, the predictions can lead to incorrect staffing and hiring decisions, or can incur large quantities of computing resources and/or human hours to validate and/or adjust the prediction results. As the example illustrates, the forecasting methods that make long-term forecasts without taking into account recent forecasting errors are deficient in that they can produce inaccurate prediction results that waste significant resources for analyzing, validating, and adjusting them.

In general, the techniques described herein implement a machine learning framework that adjusts (e.g., aggregates) the initial prediction of a long-term model with the residual prediction of a short-term model to improve forecasting accuracies. In some implementations, the residual prediction can represent a correction to the long-term model, such as a predicted difference between actual observation value(s) of the variable and a long-term prediction of the variable generated by the long-term model. In some implementations, the techniques described herein can train two independent machine learning models: (1) a long-term model that can generate an initial, long-term prediction, and (2) a short-term model that can generate, based on the recent prediction errors of the long-term model, a residual prediction as a correction to the long-term model. The long-term prediction and the residual prediction can then be combined (e.g., summed up) to generate a combined prediction, which can then be used to generate one or more action recommendation(s). Additional details of the algorithm are described below.

To reiterate, these techniques as summarized above and as further described in this specification can be used in the context of consumer communications forecast, in particular, predicting call volumes and/or AHT of calls made by consumers and recommending workforce to handle the call volumes and/or AHT. However, the techniques described herein could be applied to a variety of forecasting use cases. One skilled in the art will appreciate that the techniques described herein are not limited to just these applications but can be applicable in other contexts.

For example, in some implementations, the techniques described herein for improving forecasting accuracies can be extended to sales forecasts. Sales typically demonstrate seasonal patterns (e.g., surging sales in December). A long-term model can be used to generate an initial forecast of sales taking into account such seasonal patterns, as well as other results expected over a longer period of time. A short-term model can be used to predict residuals taking into account recent events such as sales promotion events.

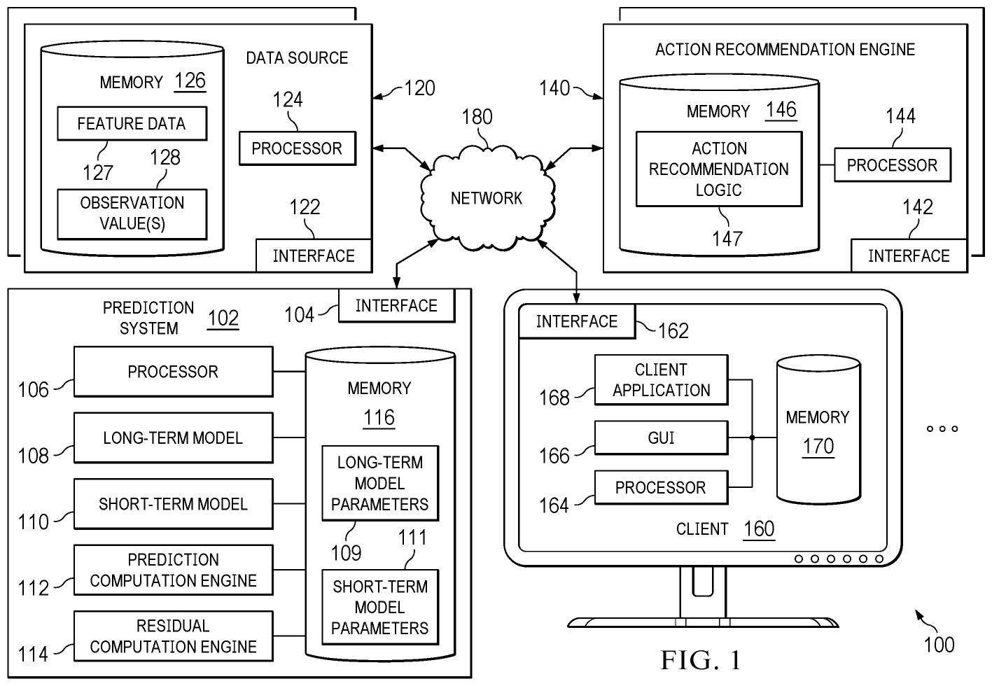

Turning to the illustrated example implementation, FIG. 1 is a block diagram of a networked environment 100 for improving forecasting accuracies based on adjusting the initial prediction of a long-term model with the residual prediction of a short-term model. As further described with reference to FIG. 1, the environment implements various systems that interoperate to use a long-term model to obtain a long-term prediction predicting a variable for a first time period, use a short-term model to obtain a residual prediction predicting a residual of the long-term model for a second time period, combine the long-term prediction and the residual prediction to generate a combined prediction, and subsequently generate action recommendation(s) based on the combined prediction.

As shown in FIG. 1, the example environment 100 includes a data source 120, a prediction system 102, an action recommendation engine 140, and multiple clients 160 that are interconnected over a network 180. The function and operation of each of these components is described below.

As described above, the example of environment 100 enables the illustrated components to share and communicate information across devices and systems (e.g., the data source 120, the prediction system 102, the action recommendation engine 140, and the client(s) 160, among others) via network 180. As described herein, the data source 120, the prediction system 102, the action recommendation engine 140, and/or the client 160 can be cloud-based components or systems (e.g., partially or fully), while in other instances, non-cloud-based systems can be used. In some instances, non-cloud-based systems, such as on-premises systems, client-server applications, and applications running on one or more client devices, as well as combinations thereof, can use or adapt the processes described herein. Although components are shown individually, in some implementations, functionality of two or more components, systems, or servers can be provided by a single component, system, or server. Conversely, functionality that is shown or described as being performed by one component, can be performed and/or provided by two or more components, systems, or servers.

As used in the present disclosure, the term “computer” is intended to encompass any suitable processing device. For example, the data source 120, the prediction system 102, the action recommendation engine 140, and/or the client 160 can be any computer or processing devices such as, for example, a blade server, general-purpose personal computer (PC), Mac®, workstation, UNIX-based workstation, or any other suitable device. Moreover, although FIG. 1 illustrates a single data source 120, a single prediction system 102, a single action recommendation engine 140, and a single client 160, any one of the data source 120, the prediction system 102, the action recommendation engine 140, and/or the client 160 can be implemented using a single system or more than those illustrated, as well as computers other than servers, including a server pool. In other words, the present disclosure contemplates computers other than general-purpose computers, as well as computers without conventional operating systems.

Similarly, the client 160 can be any system that can request data and/or interact with the data source 120, the prediction system 102, the action recommendation engine 140, and/or other client 160. The client 160, also referred to as client device 160, in some instances, can be a desktop system, a client terminal, or any other suitable device, including a mobile device, such as a smartphone, tablet, smartwatch, or any other mobile computing device. In general, each illustrated component can be adapted to execute any suitable operating system, including Linux, UNIX, Windows, Mac OS®, Java™, Android™, Windows Phone OS, or iOS™, among others. The client 160 can include one or more forecasting-specific applications executing on the client 160, or the client 160 can include one or more web browsers or web applications that can interact with particular applications executing remotely from the client 160, such as applications on the data source 120, the prediction system 102, and/or the action recommendation engine 140, among others.

As illustrated, the prediction system 102 includes or is associated with interface 104, processor(s) 106, long-term model 108, short-term model 110, prediction computation engine 112, residual computation engine 114, and memory 116. While illustrated as provided by or included in the prediction system 102, parts of the illustrated components/functionality of the prediction system 102 can be separate or remote from the prediction system 102, or the prediction system 102 can itself be distributed across the network 180.

The interface 104 of the prediction system 102 is used by the prediction system 102 for communicating with other systems in a distributed environment-including within the environment 100-connected to the network 180, e.g., the data source 120, the action recommendation engine 140, the client(s) 160, and other systems communicably coupled to the illustrated prediction system 102 and/or network 180. Generally, the interface 104 comprises logic encoded in software and/or hardware in a suitable combination and operable to communicate with the network 180 and other components. More specifically, the interface 104 can comprise software supporting one or more communication protocols associated with communications such that the network 180 and/or interface's hardware is operable to communicate physical signals within and outside of the illustrated environment 100. Still further, the interface 104 can allow the prediction system 102 to communicate with the data source 120, the action recommendation engine 140, the client 160, and/or other portions illustrated within the prediction system 102 to perform the operations described herein.

The prediction system 102, as illustrated, includes one or more processors 106. Although illustrated as a single processor 106 in FIG. 1, multiple processors can be used according to particular needs, desires, or particular implementations of the environment 100. Each processor 106 can be a central processing unit (CPU), an application specific integrated circuit (ASIC), a field-programmable gate array (FPGA), or another suitable component. Generally, the processor 106 executes instructions and manipulates data to perform the operations of the prediction system 102. Specifically, the processor 106 executes the algorithms and operations described in the illustrated figures, as well as the various software modules and functionality, including the functionality for sending communications to and receiving transmissions from the data source 120, the action recommendation engine 140, and the client(s) 160, as well as to other devices and systems. Each processor 106 can have a single or multiple cores, with each core available to host and execute an individual processing thread. Further, the number of, types of, and particular processors 106 used to execute the operations described herein can be dynamically determined based on a number of requests, interactions, and operations associated with the prediction system 102.

Regardless of the particular implementation, “software” includes computer-readable instructions, firmware, wired and/or programmed hardware, or any combination thereof on a tangible medium (transitory or non-transitory, as appropriate) operable when executed to perform at least the processes and operations described herein. In fact, each software component can be fully or partially written or described in any appropriate computer language including, e.g., C, C++, JavaScript, Java™, Visual Basic, assembler, Perl®, any suitable version of 4GL, as well as others.

The prediction system 102 can include, among other components, one or more applications, entities, programs, agents, or other software or similar components configured to perform the operations described herein. As illustrated, the prediction system 102 includes or is associated with a long-term model 108. The long-term model 108 can be any application, program, other component, or combination thereof that, when executed by the processor 106, enables to compute a long-term prediction predicting a variable for a future time period. In some cases, the long-term model 108 can be trained using, for example, the gradient descent algorithm. The long-term model 108 can be trained to generate predictions for a variety of time horizons. For example, the long-term model 108 can generate long-term predictions for a one-year period, a multi-year period, etc.

The prediction system 102 can include or be associated with a short-term model 110. The short-term model 110 can be any application, program, other component, or combination thereof that, when executed by the processor 106, enables to compute a residual prediction predicting a residual of the long-term model 108 for a future time period. The short-term model 110 can be trained to generate predictions for a variety of time horizons. For example, the short-term model 110 can generate residual prediction for a two-week period, a four-week period, etc.

The prediction system 102 can include or be associated with a prediction computation engine 112. The prediction computation engine 112 can be any application, program, other component, or combination thereof that, when executed by the processor 106, enables to compute combined predictions and/or Shapley values corresponding to the long-term prediction and residual prediction.

As illustrated, the prediction system 102 can also include memory 116, which can represent a single memory or multiple memories. The memory 116 can include any memory or database module and can take the form of volatile or non-volatile memory including, without limitation, magnetic media, optical media, random access memory (RAM), read-only memory (ROM), removable media, or any other suitable local or remote memory component. The memory 116 can store various objects or data associated with the prediction system 102, including any parameters, variables, algorithms, instructions, rules, constraints, or references thereto. While illustrated within the prediction system 102, memory 116 or any portion thereof, including some or all of the particular illustrated components, can be located remote from the prediction system 102 in some instances, including as a cloud application or repository, or as a separate cloud application or repository when the prediction system 102 itself is a cloud-based system. As demonstrated, memory 116 stores the long-term model parameters 109 and short-term model parameters 111. The long-term model parameters 109 can include, for example, a type of the long-term model 108 (e.g., Prophet, NeuralProphet, etc.), the trained feature parameters (e.g., the weights of the features) of the long-term model 108, etc. The short-term model parameters 111 can include, for example, a type of the short-term model 110 (e.g., XGBoost, etc.), the trained feature parameters (e.g., the weights of the features) of the short-term model 110, etc. In some cases, the long-term model 108 can be parameterized using the long-term model parameters 109 to perform the operations described herein. In some cases, the short-term model 110 can be parameterized using the short-term model parameters 111 to perform the operations described herein.

Network 180 facilitates wireless or wireline communications between the components of the environment 100 (e.g., between the data source 120, the prediction system 102, the action recommendation engine 140, and the client(s) 160, etc.), as well as with any other local or remote computers, such as additional mobile devices, clients, servers, or other devices communicably coupled to network 180, including those not illustrated in FIG. 1. In the illustrated environment, the network 180 is depicted as a single network, but can be comprised of more than one network without departing from the scope of this disclosure, so long as at least a portion of the network 180 can facilitate communications between senders and recipients. In some instances, one or more of the illustrated components (e.g., the data source 120, the prediction system 102, the action recommendation engine 140, and/or the client(s) 160, etc.) can be included within or deployed to network 180 or a portion thereof as one or more cloud-based services or operations. The network 180 can be all or a portion of an enterprise or secured network, while in another instance, at least a portion of the network 180 can represent a connection to the Internet. In some instances, a portion of the network 180 can be a virtual private network (VPN). Further, all or a portion of the network 180 can comprise either a wireline or wireless link. Example wireless links can include 802.11a/b/g/n/ac, 802.20, WiMax, LTE, and/or any other appropriate wireless link. In other words, the network 180 encompasses any internal or external network, networks, sub-network, or combination thereof operable to facilitate communications between various computing components inside and outside the illustrated environment 100. The network 180 can communicate, for example, Internet Protocol (IP) packets, Frame Relay frames, Asynchronous Transfer Mode (ATM) cells, voice, video, data, and other suitable information between network addresses. The network 180 can also include one or more local area networks (LANs), radio access networks (RANs), metropolitan area networks (MANs), wide area networks (WANs), all or a portion of the Internet, and/or any other communication system or systems at one or more locations.

The data source 120 can store feature data 127 in at least one memory 126 for generating the long-term predictions and/or the residual predictions. In some cases, the data source 120 can also store actual observation values 128 relating to the variables (e.g., actual observation values of call volume, AHT, etc.) in the at least one memory 126. As illustrated, the data source 120 includes various components, including interface 122 for communication (which can be operationally and/or structurally similar to interface 104), at least one processor 124 (which can be operationally and/or structurally similar to processor(s) 106, and which can execute the functionality of the data source 120), and the at least one memory 126 (which can be operationally and/or structurally similar to memory 116).

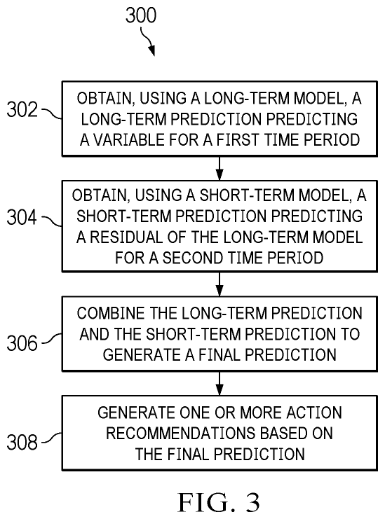

The action recommendation engine 140 can generate an action recommendation based on, for example, the combined prediction and/or the Shapley values. As illustrated, the action recommendation engine 140 includes various components, including interface 142 for communication (which can be operationally and/or structurally similar to interface 104), at least one processor 144 (which can be operationally and/or structurally similar to processor(s) 106, and which can execute the functionality of the action recommendation engine 140), and at least one memory 146 (which can be operationally and/or structurally similar to memory 116). The at least one memory 146 stores action recommendation logic 147 that, when executed by the at least one processor 144, enable to generate action recommendation(s). In some cases, the action recommendation logic 147 can include a machine learning-based solution and/or a rule-based solution (more details are described below with respect to FIG. 3).

As illustrated, one or more clients 160 can be present in the example environment 100. Although FIG. 1 illustrates a single client 160, multiple clients can be deployed and in use according to the particular needs, desires, or particular implementations of the environment 100. Each client 160 can be associated with a particular user (e.g., a user who relies on call volume/AHT predictions to perform user operations), or can be associated with/accessed by multiple users, where a particular user is associated with a current session or interaction at the client 160. Client 160 can be a client device at which the user is linked or associated. As illustrated, the client 160 can include an interface 162 for communication (which can be operationally and/or structurally similar to interface 104), at least one processor 164 (which can be operationally and/or structurally similar to processor 106), a graphical user interface (GUI) 166, a client application 168, and a memory 170 (similar to or different from memory 116) storing information associated with the client 160.

The illustrated client 160 is intended to encompass any computing device, such as a desktop computer, laptop/notebook computer, mobile device, smartphone, personal data assistant (PDA), tablet computing device, one or more processors within these devices, or any other suitable processing device. In general, the client 160 and its components can be adapted to execute any operating system. In some instances, the client 160 can be a computer that includes an input device, such as a keypad, touch screen, or other device(s) that can interact with one or more client applications, such as one or more mobile applications, including for example a web browser, a banking application, or other suitable applications, and an output device that conveys information associated with the operation of the applications and their application windows to the user of the client 160. Such information can include digital data, visual information, or a GUI 166, as shown with respect to the client 160. Specifically, the client 160 can be any computing device operable to communicate with the data source 120, the prediction system 102, the action recommendation engine 140, other client(s) 160, and/or other components via network 180, as well as with the network 180 itself, using a wireline or wireless connection. In general, the client 160 comprises an electronic computer device operable to receive, transmit, process, and store any appropriate data associated with the environment 100 of FIG. 1.

The client application 168 executing on the client 160 can include any suitable application, program, mobile app, or other component. Client application 168 can interact with the data source 120, the prediction system 102, the action recommendation engine 140, and/or other client(s) 160, or portions thereof, via network 180. In some instances, the client application 168 can be a web browser, where the functionality of the client application 168 can be realized using a web application or website that the user can access and interact with via the client application 168. In other instances, the client application 168 can be a remote agent, component, or client-side version of the action recommendation engine 140, or a dedicated application associated with the prediction system 102. In some instances, the client application 168 can interact directly or indirectly (e.g., via a proxy server or device) with the prediction system 102 or portions thereof. The client application 168 can be used to view, interact with, or otherwise transact data exchanges with the prediction system 102, and to allow interactions for generating action recommendations.

GUI 166 of the client 160 interfaces with at least a portion of the environment 100 for any suitable purpose, including generating a visual representation of any particular client application 168 and/or the content associated with any components of the data source 120, the prediction system 102, the action recommendation engine 140, and/or other client(s) 160. For example, the GUI 166 can be used to present screens and information associated with the prediction system 102 (e.g., one or more interfaces identifying combined predictions and/or Shapley values generated by the prediction system 102) and interactions associated therewith, as well as presentations associated with the data source 120 (e.g., one or more interfaces for identifying feature data and/or actual observation values), and/or recommendation-related presentations associated with the action recommendation engine 140 (e.g., one or more interfaces displaying action recommendations). GUI 166 can also be used to view and interact with various web pages, applications, and web services located local or external to the client 160. Generally, the GUI 166 provides the user with an efficient and user-friendly presentation of data provided by or communicated within the system. The GUI 166 can comprise a plurality of customizable frames or views having interactive fields, pull-down lists, and buttons operated by the user. In general, the GUI 166 is often configurable, supports a combination of tables and graphs (bar, line, pie, status dials, etc.), and is able to build real-time portals, application windows, and presentations. Therefore, the GUI 166 contemplates any suitable graphical user interface, such as a combination of a generic web browser, a web-enable application, intelligent engine, and command line interface (CLI) that processes information in the platform and efficiently presents the results to the user visually.

While portions of the elements illustrated in FIG. 1 are shown as individual components that implement the various features and functionality through various objects, methods, or other processes, the software can instead include a number of sub-modules, third-party services, components, libraries, and such, as appropriate. Conversely, the features and functionality of various components can be combined into single components as appropriate.

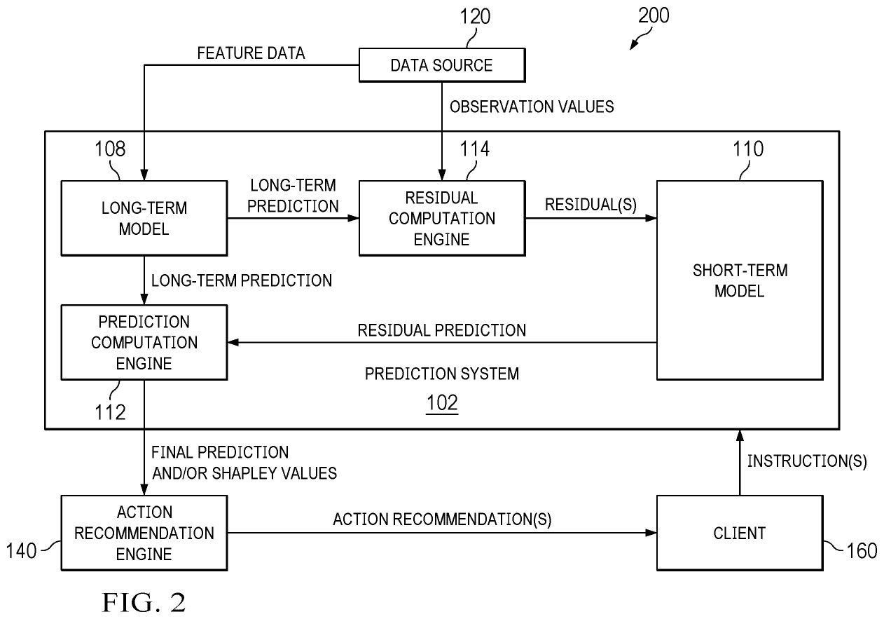

FIG. 2 illustrates an example data and control flow of example interactions 200 performed for improving forecasting accuracies based on adjusting the initial prediction of a long-term model with the residual prediction of a short-term model. As explained further below, this flow diagram describes using a long-term model to obtain a long-term prediction that predicts a variable for a first time period, using a short-term model to obtain a residual prediction that predicts a residual of the long-term model for a second time period, combining the long-term prediction and the residual prediction to generate a combined prediction, and subsequently generating action recommendation(s) based on the combined prediction. As illustrated, FIG. 2 shows interactions between the data source 120, the prediction system 102, the long-term model 108, the short-term model 110, the prediction computation engine 112, the residual computation engine 114, the action recommendation engine 140, and the client 160.

As illustrated in FIG. 2, the long-term model 108 can receive or obtain a set of feature data from data source(s) 120 (e.g., one or more data sources). In some examples, the long-term model 108 can utilize the data source(s) 120 to obtain (e.g., over a network interface) data relating to feature values associated with a variable (e.g., call volume, AHT, etc.) over a past period of time (e.g., feature values associated with seasonality features of call volume and/or AHT over the past six months, one year, two years, etc.). For ease of reference and discussion, the following description describes the operations of the data source 120, the prediction system 102, the long-term model 108, the short-term model 110, the prediction computation engine 112, the residual computation engine 114, the action recommendation engine 140, and the client 160, as being performed with respect to a particular variable. However, it will be understood that the same operations would be performed for other variable(s). In this specification, the term “engine” is used broadly to refer to a software-based system, subsystem, or process that is programmed to perform one or more specific functions. Generally, an engine will be implemented as one or more software components, installed on one or more computers in one or more locations. In some cases, one or more computers will be dedicated to a particular engine; in other cases, multiple engines can be installed and running on the same computer or computers. In some implementations, an engine includes one or more processors that can be assigned exclusively to that engine, or shared with other engines.

After receiving the set of feature data from the data source(s) 120, the long-term model 108 (e.g., a machine learning model) can generate a long-term prediction predicting the variable for a first time period. The long-term prediction can be, for example, a numerical value (e.g., call volume and/or AHT for one day), an array of numerical values (e.g., call volume and/or AHT for each day over the next year), or any other suitable output. In some cases, the long-term model 108 can transmit the long-term prediction to the residual computation engine 114 and the prediction computation engine 112, respectively.

In addition to the long-term prediction, the residual computation engine 114 can receive actual observation value(s) of the variable from data source(s) 120. The actual observation value(s) can be, for example, the actual observation value(s) of call volume, AHT, etc. The residual computation engine 114 can generate one or more residuals based on, for example, subtracting the long-term prediction from the actual observation value(s) of the variable (more details are described below with respect to FIG. 3). The residual computation engine 114 can transmit the generated residual(s) to the short-term model 110.

The generated residual(s) and/or statistics computed on the generated residual(s) (e.g., mean and standard deviation of the generated residual(s)) can be input into the short-term model 110 to generate a residual prediction. In some cases, the generated residual(s) can be used to retrain and refine the short-term model 110 (more details are described below with respect to FIG. 3). The short-term model 110 can transmit the residual prediction to the prediction computation engine 112.

The prediction computation engine 112 can combine (e.g., sum up) the long-term prediction and the residual prediction to generate a combined prediction. In some cases, the prediction computation engine 112 can compute Shapley values—which can show the contribution or the importance of each feature on the prediction of the model—to explain the long-term prediction and/or the residual prediction. In some instances, the Shapley values can be used to generate the action recommendation(s) and/or automatically execute the recommended action(s) when the Shapley values satisfy certain condition(s) (more details are described below with respect to FIG. 3). The prediction computation engine 112 can transmit the combined prediction and/or the Shapley values to the action recommendation engine 140.

The action recommendation engine 140 can generate one or more action recommendations based on the combined prediction. The one or more action recommendations can be, for example, a recommended quantity of call center staff for each day for a period of time, a recommended quantity of call center staff to hire, etc. In some cases, the action recommendation engine 140 can use the Shapley values to recommend an action, such as retraining the long-term model 108, if the Shapley values satisfy certain condition(s) (more details are described below with respect to FIG. 3). The action recommendation engine 140 can transmit the action recommendation(s) to the client 160.

The client 160 can execute one or more actions included in the action recommendation(s). For one example, the client 160 can automatically send a notification (e.g., an email) to each staff on the duty roster to notify them of their work schedule. For another example, the client 160 can send instruction(s) to the prediction system 102 to retrain the long-term model 108 and/or the short-term model 110, if the Shapley values satisfy certain condition(s).

It should be noted that FIG. 2 only provides an example of the flows and interactions between an example set of components performing the operations described herein. Additional, alternative, or different combinations of components, interactions, and operations can be used in different implementations.

FIG. 3 is a flow diagram of an example method 300 for improving forecasting accuracies based on adjusting the initial prediction of a long-term model with the residual prediction of a short-term model. As explained further below, this flow diagram describes using a long-term model to obtain a long-term prediction predicting a variable for a first time period, using a short-term model to obtain a residual prediction predicting a residual of the long-term model for a second time period, combining the long-term prediction and the residual prediction to generate a combined prediction, and subsequently generating action recommendation(s) based on the combined prediction. It should be understood that method 300 can be performed, for example, by any suitable system, environment, software, and hardware, or a combination of systems, environments, software, and hardware as appropriate. In some instances, method 300 can be performed by a system including one or more components of the environment 100, including, among others, the prediction system 102 and the action recommendation engine 140, or portions thereof, described in FIG. 1, as well as other components or functionality described in other portions of this description. In other instances, the method 300 can be performed by a plurality of connected components or systems, such as those illustrated in FIG. 2. Any suitable system(s), architecture(s), or application(s) can be used to perform the illustrated operations.

At 302, a prediction system (e.g., the prediction system 102) can obtain, using a long-term model (e.g., the long-term model 108), a long-term prediction predicting a variable for a first time period. In some cases, the long-term model can be a supervised machine learning model (e.g., Prophet, NeuralProphet, etc.) trained using historical data collected over a past period of time (e.g., six months, one year, two years, etc.). The long-term prediction can be the prediction of a variable for a future period of time. The long-term prediction can be, for example, a numerical value (e.g., call volume and/or AHT for one day), an array of numerical values (e.g., call volume and/or AHT for each day over the next year), or any other suitable set of information. In some cases, the historical data can be call volume and/or AHT for each day over the past 23 months. The long-term model can be trained using the historical data and then generate predicted call volume and/or AHT for each day over the next 12 months.

In some cases, the long-term model can generate the long-term prediction of the variable using input(s) including, for example, seasonality features of the variable, such as month of the year, holidays, long-term linear trend effects, etc. In some implementations, the inputs to the long-term model can include longer-term seasonal effects that may or may not repeat such as COVID-19 lockdowns. In some cases, these longer-term seasonal effects can be modelled using Fourier series.

In some implementations, the long-term model can be trained using a set of training data and a corresponding set of labels, where the training data can include multiple sets of data relating to feature values associated with the variable over a past period of time (e.g., six months, one year, two years, etc.), and labels in the corresponding set of labels identify corresponding values of the variable (e.g., call volume and/or AHT). For example, a piece of training data can include feature values associated with seasonality features of call volume and/or AHT. The label can be, for example, the call volume and/or AHT associated with the feature values of the seasonality features. The long-term model can be trained by optimizing a loss function based on a difference between the model's output during training and the corresponding label.

At 304, the prediction system can obtain, using a short-term model (e.g., the short-term model 110), a residual prediction predicting a residual of the long-term model for a second time period. In some implementations, the residual prediction can represent a correction to the long-term model, such as a predicted difference between actual observation value(s) of the variable and a long-term prediction of the variable generated by the long-term model. In some cases, the first time period, which is the period of the long-term model, can include the second time period. For example, the first time period can be a one-year period and the second time period can be a two-week period within the one-year period. In some implementations, the short-term model can be a supervised machine learning model (e.g., XGBoost).

In some cases, the short-term model can be trained using auto-regressive features of the past residuals to predict a residual of the future. As an example process of generating a past residual, the long-term model can first generate a long-term prediction of a variable. Once a period of time transpires, actual observation value(s) of the variable over the period of time can be obtained. The long-term prediction generated by the long-term model for the period of time can then be subtracted from the actual observation value(s) of the variable to generate a past residual. Specifically, the past residual can be represented by the following equation:

$${R}_{t} = {A}_{t} - {\hat{L}}_{t}$$

In this equation, the variable Rₜ represents the past residual. The variable Aₜ represents the actual observation value of the variable at a time point t (e.g., actual call volume/AHT for day t). The \hat{L}ₜ represents the prediction of the variable generated by the long-term model for the time point t (e.g., predicted call volume/AHT for day f). The time point t can be, for example, a day, a week, or any other time period. This process can be repeated continuously (e.g., periodically) to generate more past residuals for training the short-term model and/or providing input for the short-term model to generate residual predictions.

For example, the long-term model can first generate a prediction of call volume for each day over the next 12 months. After two weeks, the actual call volume for each day over these two weeks can be obtained. In one particular example, for each day in the two weeks, a prediction error can be calculated by subtracting the predicted call volume for the day from the actual call volume for the day. By doing so, a past residual including 14 numerical values—that is, the difference for each day in the two weeks—can be generated. For every two-week period, a past residual can be generated by using this process. The past residuals can then be used to train the short-term model and/or provide input for the short-term model to generate residual predictions.

In some implementations, the short-term model can be trained using a set of training data and a corresponding set of labels, where the training data can include multiple sets of data relating to past residuals computed for a past period of time (e.g., a two-week period starting from four weeks ago, a two-week period starting from six weeks ago, etc.), and labels in the corresponding set of labels identify recent residuals (e.g., a two-week period starting from two weeks ago). For example, a piece of training data can include one or more (e.g., five) residuals over a past period of time (also referred to as “lags”). Additionally, in some cases, each piece of training data can include, for example, statistics computed on the one or more residuals, such as mean and standard deviation of the one or more residuals. The label can be, for example, a most recent residual for a period of time that is immediately after the past period of time corresponding to the training data. For example, a piece of training data can include five residuals for five respective two-week periods starting from 12 weeks ago, 10 weeks ago, 8 weeks ago, 6 weeks ago, 4 weeks ago, respectively. The training data's corresponding label can be a residual for a two-week period starting from 2 weeks ago (that is, the two-week period ends today). The short-term model can be trained by optimizing a loss function based on a difference between the model's output during training and the corresponding label. When trained in this manner, the short-term model specializes in correcting for the mistakes of the long-term model based on the recent trends in its residuals.

In some instances, the past residual(s) (e.g., past five residuals) and/or statistics computed on the past residual(s) (e.g., mean and standard deviation of the past residual(s)) can be input into the short-term model to generate a residual prediction. By predicting a future residual in this manner, the short-term model can use the auto-regressive features of the past residual to predict future residuals. As described above, the long-term model and the short-term model can have different features. One advantage of having different features between the models is that it reduces the correlation between model predictions and therefore reduces the variance of the combined prediction of the overall ensemble. The variance, along with the bias, are the two major components of error in the bias-variance decomposition of loss functions including squared error.

At 306, the prediction system can combine (e.g., by using the prediction computation engine 112) the long-term prediction and the residual prediction to generate a combined prediction. In some instances, the residual prediction can be added to the long-term prediction to generate the combined prediction. For example, assuming that at end of day t we want to predict the daily call volume for tomorrow (i.e., day t+1), the long-term prediction generated by the long-term model for day t+1 and the residual prediction generated by the short-term model for day t+1 can be added. In some cases, since at the end of day t we know the actual observation value for day t, the short-term model can be trained up to day t. This example combined prediction can be represented by the following equation:

$${\hat{F}}_{t + 1} = {\hat{L}}_{t + 1} + {\hat{S}}_{t + 1}^{t}$$

In this equation, the variable \hat{F}ₜ₊₁ represents the combined prediction for the day t+1. The variable \hat{L}ₜ₊₁ represents the long-term prediction for the day t+1. The variable Ŝₜ₊₁^{t} represents the residual prediction for the day t+1 generated by the short-term model which has been trained up to day t.

At 308, the prediction system can generate one or more action recommendations (e.g., using the action recommendation engine 140) based on the combined prediction. For example, the combined prediction can be predicted call volume and/or AHT for a future period of time, and the one or more action recommendations can be, for example, a recommended quantity of call center staff for each day for the future period of time, a recommended quantity of call center staff to hire for the future period of time, etc. In some cases, the one or more action recommendations can be evaluated by analysts to determine the final action(s).

In some cases, the prediction system can generate these action recommendations using action recommendation logic (e.g., the action recommendation logic 147) based on the combined prediction. In some implementations, the action recommendation logic can include a machine learning-based solution. The action recommendation logic can include a machine-learning model that takes the combined prediction as input, and outputs the one or more action recommendations. For example, the predicted call volume and/or AHT can be input into the machine learning model to generate the recommended quantity of call center staff, the recommended quantity of call center staff to hire, etc.

In some cases, the action recommendation logic can include a rule-based solution. For example, the action recommendation logic can include one or more rules (e.g., a decision tree, logical expression(s), etc.) that takes the combined prediction as input, and outputs the one or more action recommendations. For example, the predicted call volume and the AHT for a given day can be multiplied to generate an expected hours of calls for the given day. The expected hours of calls can be divided by the daily working hours of a call center staff to determine the recommended quantity of call center staff for the given day.

In some cases, in addition to or in the alternative to generating the one or more action recommendations, one or more actions can be executed automatically based on the combined prediction. For example, the system can generate, based on the recommended quantity of call center staff for each day for a week, a duty roster for each day of the week. The system can then automatically send a notification (e.g., an email) to each staff on the duty roster to notify them of their work schedule. In others, the system can generate a job listing request and transmit such request to an appropriate human resources representative, providing input about the relative need for more or fewer call center staff during a portion of the predicted time period based on the adjusted values.

In some cases, Shapley values—which can show the contribution or the importance of each feature on the prediction of the model—can be used to explain the long-term prediction and/or the residual prediction, so that the analysts have an understanding as to why the long-term model and/or the short-term model is forecasting certain values for certain days. Additionally, since the ensemble of the long-term prediction and the residual prediction is additive, Shapley values can still be used due to the linearity property of Shapley values. Thus, analysts can understand, for example, what drove the prediction that day (e.g., whether it was features from the short-term model or features from the long-term model that impact the combined prediction, what their estimated impact was on the combined prediction, etc.).

Using the equation \hat{F}ₜ₊₁=\hat{L}ₜ₊₁+Ŝₜ₊₁^{t} described above as an example, since the combined prediction of the combined model is in the form of an additive model, the Shapley values for each of the two model predictions (i.e., the long-term prediction and the residual prediction) can be calculated independently and added up to obtain the combined Shapley values for the entire model prediction. Due to the nature of Shapley values, the sum of the Shapley values for the residual prediction of the short-term model is Ŝₜ₊₁^{t}. Similarly, for the long-term model, the sum of the Shapley values for the long-term prediction is \hat{L}ₜ₊₁. Due to the additive form of the model, the total Shapley values of the long-term model and the short-term model sum to \hat{F}ₜ₊₁. Thus, which of the features from either the long-term model or the short-term model dominate the prediction can be determined by examining the sign and magnitude of the Shapley values associated with the short-term and long-term features. For example, if the Shapley values for the features of the long-term model are larger in magnitude, then those features are dominating the combined prediction.

In some instances, the Shapley values can be used to generate the action recommendation(s) and/or automatically execute the recommended action(s) when the Shapley values satisfy certain condition(s). In one example, if the Shapley values associated with the short-term features are large in magnitude for many samples, then it can indicate that the long-term prediction is starting to degrade in performance. As a result, a new long-term model can be retrained based on the most recent training data. For example, assume that the predictions are made for the next two weeks for a particular phone channel of a call center. If the magnitude of the Shapley values for the features of the long-term model (such as weekly and monthly seasonality, trend, holidays, etc.) has been decreasing for a period of time, it can indicate that the prediction errors of the long-term model are increasing. When a sum of the magnitude of the Shapley values for the features of the long-term model are less than a predetermined threshold (e.g., 50%) of the total sum of the Shapley values for both models, it can indicate that it is time to retrain the long-term model as the seasonality and trend effects it has learned during previous years are no longer holding. Accordingly, in some cases, retraining the long-term model can be added to the action recommendation(s) as a recommended action to be executed. In some cases, the retraining of the long-term model can be automatically triggered under this condition.

Another example involves the impacts of holidays to the predictions. Holidays typically have a large effect on call volumes. For example, call volumes can significantly increase during holidays. If the magnitude of the Shapley values for holiday features are decreasing over time, it can indicate that the typical patterns of holidays that the model(s) learned during previous years are changing. An example of such pattern change is that the customers can call in days surrounding the holidays rather than the holiday themselves. In some cases, such Shapley value changes can trigger an investigation of the long-term model and/or short-term model and adjust the feature(s) accordingly. For example, if the Shapley value change satisfies a predetermined condition (e.g., meets or exceeds a predetermined threshold), retraining the long-term model can be added to the action recommendation(s) as a recommended action to be executed. In some instances, the retraining of the long-term model can be automatically triggered using recent training data that reflects the changed holiday patterns.

In another example, the Shapley values can be used to assess the effect of a feature on the combined prediction and notify a corresponding team. For example, assume that the long-term model includes a feature associated with recurring marketing campaigns, the Shapley values of the feature can be monitored over time and used as one metric of assessing the effect of the campaign on the call volume demand. For recurring marketing campaigns, if the Shapley value for a future prediction has a large magnitude with reference to the other Shapley values, a notification can be automatically generated and sent to the marketing team. The marketing team can perform one or more operations based on the notification, such as collecting observational information on the estimated effect of the campaign on the model forecast.

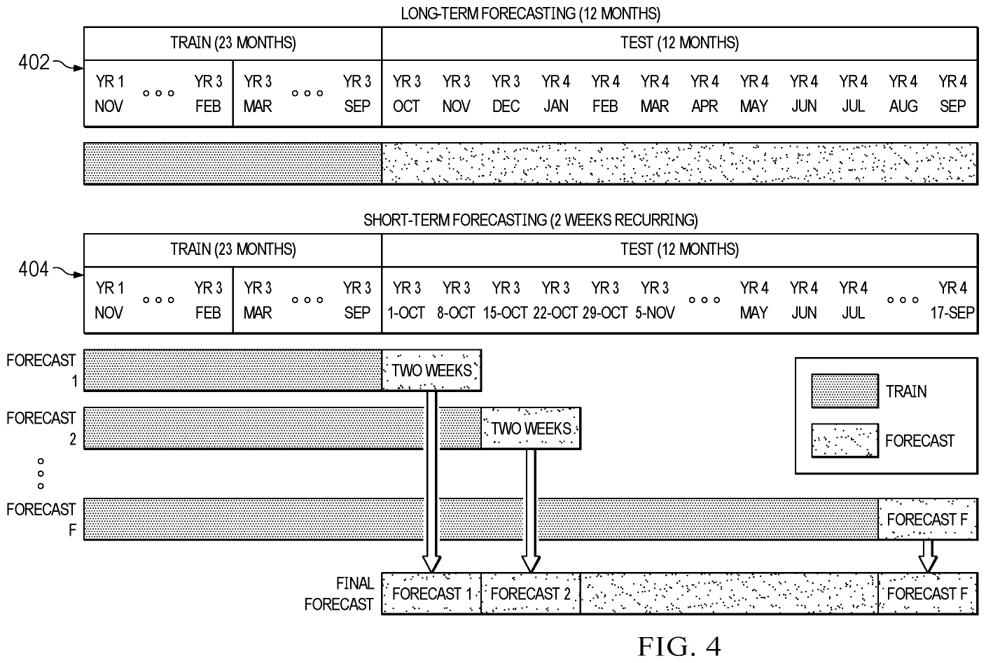

FIG. 4 illustrates an example process for improving forecasting accuracies based on adjusting the initial prediction of a long-term model with the residual prediction of a short-term model. As illustrated, the example method generally includes two steps: long-term forecasting 402 and short-term forecasting 404. In some cases, FIG. 4 illustrates some examples of the techniques in the embodiments discussed above. For example, the long-term forecasting 402 can be an example process of the Step 302 as described in FIG. 3, whereas the short-term forecasting 404 can be an example process of the Steps 304 and 306 as described in FIG. 3.

In the long-term forecasting 402, a long-term model (e.g., the long-term model 108) can be trained using historical data (e.g., all volume and/or AHT) collected over the past 23 months (that is, from November of Year 1 to September of Year 3). The training of the long-term model can be based on, for example, the training process as described in Step 302 of FIG. 3, and the details are omitted here for brevity. As illustrated, the trained long-term model can generate a long-term prediction predicting a variable (e.g., all volume and/or AHT) for a 12-month period from October of Year 3 to September of Year 4.

As illustrated, the short-term forecasting 404 occurs every two weeks. Similar as the long-term model, a short-term model (e.g., the short-term model 110) can be trained using historical data (e.g., all volume and/or AHT) collected over the past 23 months (that is, from November of Year 1 to September of Year 3). The training of the short-term model can be based on, for example, the training process as described in Step 304 of FIG. 3, and the details are omitted here for brevity. In each short-term forecasting, the short-term model can generate a residual prediction predicting a residual of the long-term model for the following two weeks. For example, before the beginning of October 1, Year 3, a residual prediction for a two-week period from October 1, Year 3 to October 14, Year 3 can be generated. For another example, before the beginning of October 15, Year 3, another residual prediction for another two-week period from October 15, Year 3 to October 28, Year 3 can be generated. The residual prediction of each two-week period can be added to the long-term prediction of the same two-week period to generate a combined prediction for the two-week period. For example, the residual prediction from October 1, Year 3 to October 14, Year 3 can be added to the long-term prediction of the same two-week period (that is, from October 1, Year 3 to October 14, Year 3) to generate a combined prediction Forecast 1. As illustrated, the combined prediction can be repeatedly generated for each two-week period to generate Forecast 1 to Forecast F.

In some cases, the short-term model can be retrained after each two-week period transpires. In some implementations, retraining the short-term model can be based on similar operations as described in Step 304 of FIG. 3. For example, after the first two-week period from October 1, Year 3 to October 14, Year 3, actual observation values of the variable over the two-week period can be obtained. For each day of the two-week period, a prediction error of the long-term model for the day can be measured by subtracting the long-term prediction of the day from the actual observation value for the day. For example, a prediction error of the long-term model for October 1, Year 3 can be measured by subtracting the long-term prediction of October 1, Year 3 from the actual observation value for October 1, Year 3. A prediction error can be generated for each day of the two weeks, so this process can generate a historical residual including 14 numerical values, representing the prediction errors for each day in the two-week period. This historical residual can be used to retrain the short-term model, which can then generate another short-term forecast for the next two-week period, that is, the two-week period from October 15, Year 3 to October 28, Year 3. By retraining the short-term model using the most recent observation values, the short-term model can learn the recent trends of the long-term model's prediction errors, and can correct for the mistakes of the long-term model accordingly. In some cases, this retraining process can be repeated for each two-week period from Forecast 1 to Forecast F.

Table 1 shows example performance comparisons of the techniques described herein and the manual forecasting methods. In Table 1, the “combined model” represents combining the long-term prediction and residual prediction, as described in the previous figures. “Manual forecasting” represents the manual forecasting methods that rely on analysts to make predictions. Table 1 compares the “combined model” and the “manual forecasting” using mean absolute error (MAE) and symmetric mean absolute percentage error (SMAPE). A smaller MAE corresponds to a smaller difference between the prediction and the actual observation value. Similarly, a smaller SMAPE corresponds to a smaller difference between the prediction and the actual observation value. So, smaller MAE or smaller SMAPE indicates more accurate prediction results. The table compares the “combined model” and the “manual forecasting” based on their predicted call volumes and AHTs. As Table 1 shows, regarding the call volume, the accuracy of the combined model almost matches that of the manual prediction, with only slightly greater MAE and SMAPE. On the other hand, regarding the AHT, the combined model outperforms the manual forecasting method in both of the MAE and SMAPE. Therefore, Table 1 demonstrates that the techniques described herein can enhance the accuracies of call volume and/or AHT predictions.

TABLE 1

| | | | | Difference from |
|---|---|---|---|---|
| Model | Target | MAE | SMAPE | MAE Manual |
| Manual forecasting | Call Volume | 1110.87 | 11.34% | − |
| Combined model | Call Volume | 1175.62 | 12.39% | +64.75 |
| Manual forecasting | AHT | 29.93 s | 4.02% | − |
| Combined model | AHT | 28.09 s | 3.78% | −1.84 s |

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage media (or medium) for execution by, or to control the operation of, data processing apparatus. Alternatively, or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program can, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A system comprising:
at least one memory storing instructions;
a network interface; and
at least one hardware processor interoperably coupled with the network interface and the at least one memory, wherein execution of the instructions by the at least one hardware processor causes performance of operations comprising:
obtaining, using a first machine learning model, a first prediction predicting a variable for a first time period;
obtaining, using a second machine learning model, a second prediction predicting a residual of the first machine learning model for a second time period, wherein the first time period comprises the second time period, and wherein the second machine learning model is trained based on at least a part of the first prediction;
combining the first prediction and the second prediction to generate a combined prediction; and
generating one or more action recommendations based on the combined prediction.

2. The system of claim 1, the operations comprising:
obtaining one or more past residuals of the first machine learning model; and
training, using the one or more past residuals, the second machine learning model.

3. The system of claim 2, wherein obtaining the one or more past residuals of the first machine learning model comprises:
obtaining the at least a part of the first prediction, wherein the at least a part of the first prediction is associated with a third time period, and the first time period comprises the third time period;
obtaining an actual observation value of the variable for the third time period; and
subtracting the at least a part of the first prediction from the actual observation value to generate a past residual.

4. The system of claim 3, wherein the first time period is relatively longer than the second time period.

5. The system of claim 1, wherein combining the first prediction and the second prediction to generate the combined prediction comprises:
adding the second prediction to the at least a part of first prediction.

6. The system of claim 1, wherein generating the one or more action recommendations based on the combined prediction comprises:
determining one or more Shapley values associated with the combined prediction; and
determining that the one or more Shapley values satisfy one or more conditions.

7. The system of claim 6, the operations comprising:
in response to determining that the one or more Shapley values satisfy the one or more conditions, adding one or more actions to the one or more action recommendations.

8. The system of claim 7, wherein the one or more conditions comprise a condition that a sum of Shapley values associated with the first machine learning model are less than a predetermined ratio of a total sum of the Shapley values associated with the first machine learning model and Shapley values associated with the second machine learning model, and wherein the one or more actions comprise retraining the first machine learning model.

9. The system of claim 8, the operations comprising:
in response to determining that the sum of Shapley values associated with the first machine learning model are less than the predetermined ratio of the total sum of the Shapley values associated with the first machine learning model and the Shapley values associated with the second machine learning model, automatically triggering retraining of the first machine learning model.

10. The system of claim 1, wherein the first machine learning model and the second machine learning model have at least one different feature.

11. A computer-implemented method, comprising:
obtaining, using a first machine learning model, a first prediction predicting a variable for a first time period;
obtaining, using a second machine learning model, a second prediction predicting a residual of the first machine learning model for a second time period, wherein the first time period comprises the second time period, and wherein the second machine learning model is trained based on at least a part of the first prediction;
combining the first prediction and the second prediction to generate a combined prediction; and
generating one or more action recommendations based on the combined prediction.

12. The computer-implemented method of claim 11, comprising:
obtaining one or more past residuals of the first machine learning model; and
training, using the one or more past residuals, the second machine learning model.

13. The computer-implemented method of claim 12, wherein obtaining the one or more past residuals of the first machine learning model comprises:
obtaining the at least a part of the first prediction, wherein the at least a part of the first prediction is associated with a third time period, and the first time period comprises the third time period;
obtaining an actual observation value of the variable for the third time period; and
subtracting the at least a part of the first prediction from the actual observation value to generate a past residual.

14. The computer-implemented method of claim 13, wherein the first time period is relatively longer than the second time period.

15. The computer-implemented method of claim 14, wherein combining the first prediction and the second prediction to generate the combined prediction comprises:
adding the second prediction to the at least a part of first prediction.

16. The computer-implemented method of claim 15, wherein generating the one or more action recommendations based on the combined prediction comprises:
determining one or more Shapley values associated with the combined prediction; and
determining that the one or more Shapley values satisfy one or more conditions.

17. The computer-implemented method of claim 16, comprising:
in response to determining that the one or more Shapley values satisfy the one or more conditions, adding one or more actions to the one or more action recommendations.

18. The computer-implemented method of claim 17, wherein the one or more conditions comprise a condition that a sum of Shapley values associated with the first machine learning model are less than a predetermined ratio of a total sum of the Shapley values associated with the first machine learning model and Shapley values associated with the second machine learning model, and wherein the one or more actions comprise retraining the first machine learning model.

19. The computer-implemented method of claim 18, comprising:
in response to determining that the sum of Shapley values associated with the first machine learning model are less than the predetermined ratio of the total sum of the Shapley values associated with the first machine learning model and the Shapley values associated with the second machine learning model, automatically triggering retraining of the first machine learning model.

20. A non-transitory, computer-readable medium storing computer-readable instructions, that upon execution by at least one hardware processor, cause performance of operations, comprising:
obtaining, using a first machine learning model, a first prediction predicting a variable for a first time period;
obtaining, using a second machine learning model, a second prediction predicting a residual of the first machine learning model for a second time period, wherein the first time period comprises the second time period, and wherein the second machine learning model is trained based on at least a part of the first prediction;
combining the first prediction and the second prediction to generate a combined prediction; and
generating one or more action recommendations based on the combined prediction.
